(19) United States
(12) Patent Application Publication
(10) Pub. No.: US 2009/0190638 A1
(43) Pub. Date: Jul. 30, 2009

(54) Automatic Downstream Calibration

(75) Inventors: Moshe Meir, Mazkeret Batya (IL); Damian Moreno, Netanya (IL); Oren Ben Hamo, Rehovot (IL); Ronen Ezra, Kfar Saba (IL)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/359,667

(22) Filed: Jan. 26, 2009

Related U.S. Application Data
(60) Provisional application No. 61/023,148, filed on Jan. 24, 2008.

(51) Int. Cl. H04L 5/16

(52) U.S. Cl. 375/222

(57) ABSTRACT

Embodiments of the invention provide a method for auto calibration with fix and stable power wide band noise at the cable modem input without any need to change input power by using PHY back-off variation at the ADC input. The wide band tuner's IF VGA calibration is accomplished by freezing RF agcs at specific state and back off variation of the ADC input.

### CROSS-REFERENCE TO RELATED APPLICATIONS

This application claims priority to and incorporates by reference U.S. Provisional Application No. 61/023,148, filed Jan. 24, 2008, entitled “AUTOMATIC DOWNSTREAM CALIBRATION WITH FIX INPUT POWER BY USING ADC BACK OFF VARIATION AND WITHOUT USAGE OF EXTERNAL PC SOFTWARE”, Moshe Meir, Damian Moreno, Oren Ben Hamo, Ronen Ezra, inventors. Said application incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Embodiments of the invention are directed, in general, data communications over a network, more particularly, auto calibration using analog digital converter ADC back off.

To aid in understanding the principles of the embodiments of the invention, the description is provided in the context of a Data-Over-Cable Service Interface Specification (DOCSIS) enabled communications system, in particular DOCSIS 3.0 systems which support data transmission over N (e.g., four) physical channels. It is appreciated, however, that the embodiments are not limited to use with any particular communication standard and may be used in cable, optical, wired, wireless or other applications. Furthermore, the embodiments are not limited to use with a specific modulation scheme but is applicable to any modulation scheme including both digital and analog modulation.

Note that throughout this document, the term communications transceiver, communications device or network device is defined as any apparatus or mechanism adapted to transmit, receive or transmit and receive information through a medium. The communications device, communications transceiver or network device may be adapted to communicate over any suitable medium, including wireless or wired media. Examples of wireless media include, but not limited to: RF, infrared, coaxial, optical, microwave, UWB, Bluetooth, WiMAX, GSM, EDGE, UMTS, WCDMA, 3GPP-LTE, CDMA-2000, EVDO, EVDV, UMB, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The terms communications device, communications transceiver or network device are also intended to denote other devices including, but not limited to, a set top box, cable modem, EMTA, residential gateway cable device, embedded cable modem, a multimedia player, mobile communication device, cellular phone, node in a broadband wireless access (BWA) network, smartphone, PDA, wireless LAN (WLAN) and Bluetooth device.

The term cable modem is defined as a modem that provides access to a data signal sent over the cable television infrastructure. The term voice cable modem is defined as a cable modem that incorporates VoIP capabilities to provide telephone services to subscribers. The term ‘essential code’ is defined as code required to enable the communication device to boot and repeatedly attempt to download and install the full-functionality software upgrade until it is successfully installed. The term ‘non-essential’ code refers to all other code including not only operating system software, but other code for proper operation of the cable modem, such as in a DOCSIS compliant manner.

The word ‘exemplary’ is used herein to mean ‘serving as an example, instance, or illustration.’ Any embodiment described herein as ‘exemplary’ is not necessarily to be construed as preferred or advantageous over other embodiments.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

There is a need for a new technique that allows for improved calibration techniques to, inter alia, reduced calibration time on production, simplify the calibration station and eliminate the need of external computer control.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrative of a cable modem system incorporating the auto calibration embodiments of the invention.

FIG. 2 is a block diagram illustrative of an example cable modem incorporating embodiments of the invention.

FIG. 3 is a block diagram of the Illustrative of the TNETC550W and TNETC550LC platforms of preferred embodiments of the invention.

FIG. 4 is a block diagram illustrative of the automatic calibration phase improvement the FIG shows two ways of calibration comparing the prior art calibration to calibration in accordance with embodiments of the invention.

FIG. 5 is a block diagram illustrative of the architecture for analog/RF downstream path.

FIG. 6 is a block diagram illustrative of the digital front end of FIG. 5 in accordance with an embodiment of the invention.

FIG. 7 shows the noise source used to calibrate the device.

FIG. 8 shows a IF-AGC gain to voltage relation

FIG. 9 is a graph illustrative of the calibration process based on a power reference value.

FIG. 10 is a flowchart illustrative of a method in accordance with an embodiment of the invention.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

Embodiments of the invention eliminate the control of the external equipment as the digital attenuator to simplify the setup and reduce calibration time. The embodiments also allow parallel calibration of quantities of products

Currently there are more than 50 million high-speed Internet access customers in North America. Recently, the cable modem has become the broadband connection of choice for many Internet users, being preferred over the nearest rival broadband technology, Digital Subscriber Line (DSL), by a significant margin.

Cable modems are well known in the art. A cable modem (CM) is a type of modem that provides access to a data signal sent over the cable television (CATV) infrastructure. Cable modems are primarily used to deliver broadband Internet access, taking advantage of unused bandwidth on a cable television network. In 2005 there were over 22.5 million cable modem users in the United States alone.

A cable modem is a network appliance that enables high speed data connections to the internet via data services provided by the local cable company. Data from the home is sent upstream on a carrier that operates on the 5 MHz to 42 MHz band of the cable spectrum—65 Mhz in Europe. Downstream data is carried on a 88 MHz to 860 MHz band and 108 to 860 MHz in Europe. The cable modem system can have additional networking features such as Voice over IP (VoIP), wireless connectivity or network switch or hub functionality.

The term cable Internet access refers to the delivery of Internet service over the cable television infrastructure. The proliferation of cable modems, along with DSL technology, has enabled broadband Internet access in many countries. The bandwidth of cable modem service typically ranges from 3 Mbps up to 40 Mbps or more. The upstream bandwidth on residential cable modem service usually ranges from 384 kbps to 30 Mbps or more. In comparison, DSL tends to offer less speed and more variance between service packages and prices. Service quality is also far more dependent on the client's location in relation to the telephone company's nearest central office or Remote Terminal.

Users in a neighborhood share the available bandwidth provided by a single coaxial cable line. Therefore, connection speed varies depending on how many people are using the service at the same time. In most areas this has been eliminated due to redundancy and fiber networks.

With the advent of Voice over IP telephony, cable modems are also be used to provide telephone service. Many people who have cable modems have opted to eliminate their Plain Old Telephone Service (POTS). An alternative to cable modems is the Embedded Multimedia Terminal Adapter (EMTA). An EMTA allows multiple service operators (MSOs) to offer both High Speed Internet and VoIP through a single piece of customer premise equipment. A multiple system operator is an operator of multiple cable television systems.

Many cable companies have launched Voice over Internet Protocol (VoIP) phone service, or digital phone service, providing consumers a true alternative to standard telephone service. Digital phone service takes the analog audio signals and converts them to digital data that can be transmitted over the hybrid fiber coaxial (HFC) network of the cable company. Cable digital phone service is currently available to the majority of U.S. homes with a large number of homes are now subscribing. The number of homes subscribing is currently growing by hundreds of thousands each quarter. One significant benefit of digital phone service is the substantial consumer savings, with one recent study saying residential cable telephone consumers could save an average of $135 or more each year.

The Data Over Cable Service Interface Specification (DOCSIS) compliant cable modems have been fueling the transition of cable television operators from a traditional core business of entertainment programming to a position as full-service providers of video, voice, and data telecommunications services.

The latest DOCSIS specification, DOCSIS 3.0, include a number of enhancements, most notably, channel bonding and support for IPv6. Channel bonding provides cable operators with a flexible way to increase upstream and downstream throughput to customers, with data rates in the hundreds of megabits and potentially gigabits per second. DOCSIS 3.0 increases the capacity of cable modems to a minimum of 160 Mbps downstream to customers and to a minimum of 120 Mbps upstream.

Cable systems transmit digital data signals over radio frequency (RF) carrier signals. To provide two-way communication, one carrier signal carries data in the downstream direction from the cable network to the customer and another carrier signal carries data in the upstream direction from the customer to the cable network. Cable modems are devices located at the subscriber premises that functions to convert digital information into a modulated RF signal in the upstream direction, and to convert the RF signals to digital information in the downstream direction. A cable modem termination system (CMTS) performs the opposite operation for multiple subscribers at the cable operator's head-end.

Typically, several hundreds of users share a 6 MHz downstream channel and one or more upstream channels. The downstream channel occupies the space of a single television transmission channel in the cable operator's channel lineup. It is compatible with digital set top MPEG transport stream modulation (64 or 256 QAM), and provides up to 40 Mbps. A media access control (MAC) layer coordinates shared access to the upstream bandwidth.

In order to provide faster data rates to customers, DOCSIS 3.0 introduces the concept of bonding several physical downstream channels into one virtual high speed pipe. Channel bonding is a load-sharing technique for logically combining multiple DOCSIS channels. DOCSIS 3.0 defines channel bonding for both the upstream and downstream directions. For downstream channel bonding, each downstream DOCSIS channel carries a payload of approximately 38 Mbps (50 Mbps with EuroDOCSIS). Load sharing traffic across multiple channels allows a maximum throughput of up to N×38 Mbps (or N×50 Mbps), with N representing the number of channels being bonded. A separate 6 MHz or 8 MHz frequency is used for each of the bonded channels. Upstream channel bonding is possible for a minimum of four channels, 10 to 30 Mbps each, for a total of 40 to 120 Mbps of shared throughput.

Cable modems and DOCSIS standard have made delivery of digital services over hybrid fiber coaxial (HFC) cable television systems possible. Digital data delivery of Internet data, video on demand movies, telephony, telephony over the Internet, interactive games, upstream delivery of security camera digital photos to security services and a host of other applications is now possible. These services and applications are useful and valuable with some requiring more bandwidth than others. Video and movies, for example, even when compressed using MPEG standards, require large amounts of bandwidth.

Based on Data Over Cable Services Interface Specification DOCSIS 3.0 standard, the cable modem (CM) required reporting its downstream input power with +/−3 db accuracy which needs to be solved by calibration of downstream path.

The calibration output is downstream gain characterizing vs. frequency and vs. input power. By knowing gain response of downstream path we can calculate the reported power. The CM needs to report the power on its RF input connectoer. The measurement is done on the chip itself. To report the power received on the input by only knowing the chip input power, the downstream chain response over gain and frequency need to be known (calibrated)

On production, each cable modem needs to be calibrated separately because of interspersion of downstream major components response as filters, tuner blocks, ADC full scale variation etc.

The embodiments may take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

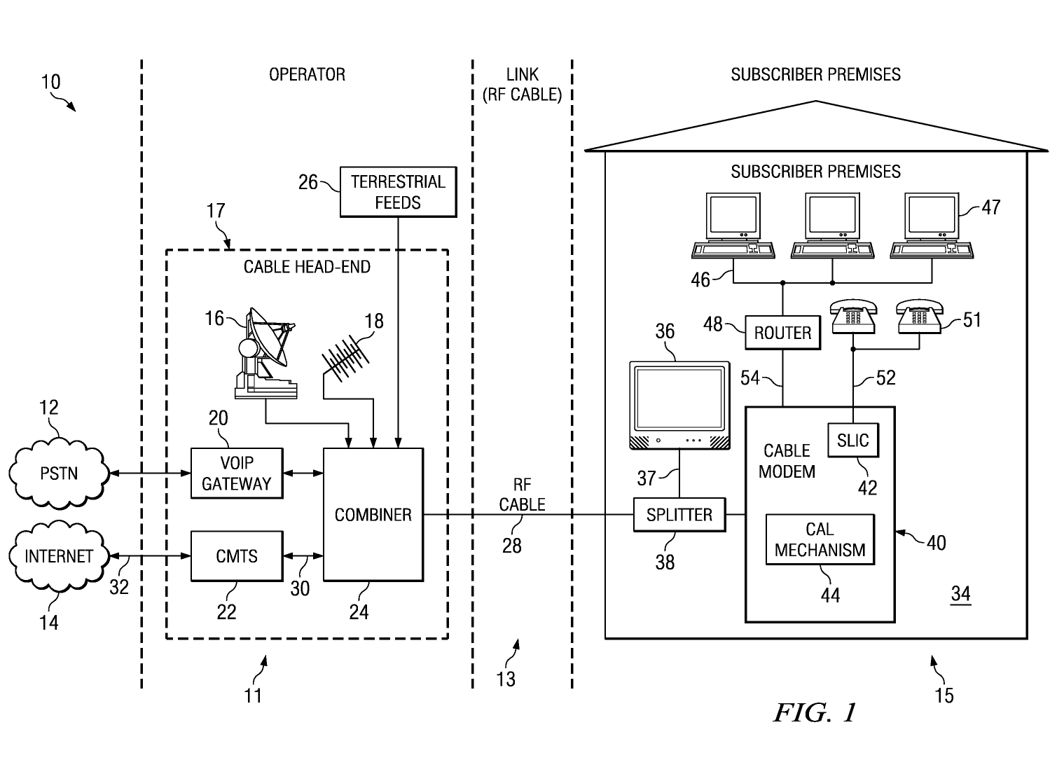

A block diagram illustrative a cable modem system incorporating the auto calibration embodiments of the invention is shown in FIG. 1. The system, generally referenced 10, comprises an operator portion 11 connected to the public switched telephone network (PSTN) 12 and the Internet 14 or other wide area network (WAN), a link portion 13 comprising the RF cable 28 and a subscriber portion 15 comprising the subscriber premises 34.

The operator portion 11 comprises the cable head-end 17 which is adapted to receive a number of content feeds such as satellite 16, local antenna 18 and terrestrial feeds 26, all of which are input to the combiner 24. The cable head-end also comprises the voice over IP (VoIP) gateway 20 and Cable Modem Termination System (CMTS) 22. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cell. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 34 comprises a splitter 38, cable appliances 36 such as televisions, DVRs, etc., cable modem 40, router 48, PCs or other networked computing devices 47 and telephone devices 51. Cable service is provided by the local cable provider wherein the cable signal originates at the cable head end facility 17 and is transmitted over RF cable 28 to the subscriber premises 34 where it enters splitter 38. One output of the splitter goes to the televisions, set top boxes, and other cable appliances via internal cable wiring 37.

The other output of the splitter comprises the data portion of the signal which is input to the cable modem 40. The cable modem is adapted to provide both Ethernet and USB ports. Typically, a router 48 is connected to the Ethernet port via Ethernet cable 54. One or more network capable computing devices 47, e.g., laptops, PDAs, desktops, etc. are connected to the router 48 via internal Ethernet network wiring 46. In addition, the router may comprise or be connected to a wireless access point that provides a wireless network (e.g., 802.11b/g/a) throughout the subscriber premises.

The cable modem also comprises a subscriber line interface card (SLIC) 42 which provides the call signaling and functions of a conventional local loop to the plurality of installed telephone devices 51 via internal 2-wire telephone wiring 52. In particular, it generates call progress tones including dial tone, ring tone, busy signals, etc. that are normally provided by the local loop from the CO. Since the telephone deices 51 are not connected to the CO, the SLIC in the cable modem must provide these signals in order that the telephone devices operate correctly.

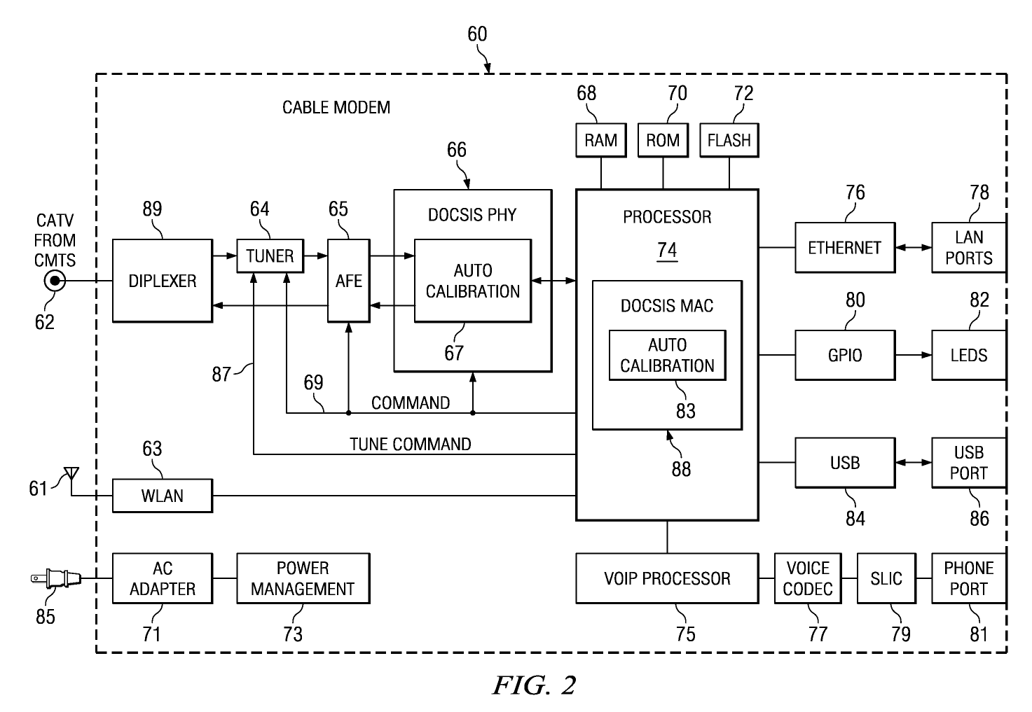

A block diagram illustrative of an example cable modem incorporating the embodiments of the invention is shown in FIG. 2. The cable modem, generally referenced 60, comprises a diplexer 89, tuner 64, analog front end (AFE) circuit 65, DOCSIS PHY circuit 66 incorporating an auto calibration block 67, DOCSIS compatible processor 74 incorporating the auto calibration block 83 within the DOCSIS MAC 88, VoIP processor 75, voice codec 77, subscriber line interface card (SLIC) 79, phone port 81, antenna 61, wireless local area network (WLAN) 63, Ethernet interface 76, Ethernet LAN port 78, general purpose (I/O) (GPIO) interface 80, LEDs 82, universal serial bus (USB) interface 84, USB port 86, AC adapter 71, power management circuit 73, ROM 68, RAM 70 and FLASH memory 72. Note that in the example embodiment presented herein, the cable modem and DOCSIS enabled processor 74 are adapted to implement the DOCSIS 3.0 standard which provides for channel bonding wherein multiple downstream channels are used to transmit data from the CMTS to the cable modem. A plurality of contexts may be established whereby packets are sent over multiple downstream channels and recombined at the cable modem to yield several separate contexts.

In operation, the cable modem processor 74 is the core chip set which in the example presented herein comprises a central single integrated circuit (IC) with peripheral functions added. Depending on the implementation, one or more of the functions shown external to the processor may be implemented within the processor without departing from the scope of the invention. For example, the AFE and PHY circuits may be implemented within the processor integrated circuit (IC) 74.

The voice over IP (VoIP) processor 75 implements a mechanism to provide phone service outside the standard telephone company POTS channel. Chipset DSPs and codecs 77 add the functionality of POTS service for low rate voice data.

The cable modem also comprises a subscriber line interface card (SLIC) 79 which functions to provide the signals and functions of a conventional local loop to a plurality of telephone devices connected via the phone port 81 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 AC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 76 and Ethernet LAN port 78, USB interface 84 and USB port 86 or with additional chip sets, such as wireless 802.11a/b/g via WLAN interface 63 coupled to antenna 61. In addition, a GPIO interface 80 provides an interface for LEDs 82, etc. The network connectivity functions may also include a router or Ethernet switch core. Note that the DOCSIS MAC 88 and PHY 66 are typically integrated into the cable modem processor 74 or may be separate as shown in FIG. 2 wherein the DOCSIS PHY circuit 66 is shown separate from the processor 74.

In the example embodiment presented herein, the diplexer 89 is coupled to the CATV signal from the CMTS via port 62 and is operative to coupled the receive and transmit signals to the CATV cable. The tuner 64 is operative to convert the RF signal received over the RF cable to an IF frequency in accordance with a tune command received from the processor.

The cable modem 60 may comprise a processor 74 which may comprise a digital signal processor (DSP), central processing unit (CPU), microcontroller, microprocessor, microcomputer, ASIC, FPGA core or any other suitable processing means. The cable modem may also comprise static read only memory (ROM) 68, dynamic main memory 70 and FLASH memory 72 all in communication with the processor via a bus (not shown).

The magnetic or semiconductor based storage device 68 (i.e. RAM) is used for storing application programs and data. The cable modem comprises computer readable storage medium that may include any suitable memory means, including but not limited to, magnetic storage, optical storage, semiconductor volatile or non-volatile memory, biological memory devices, or any other memory storage device.

Software adapted to implement the embodiments of the invention is adapted to reside on a computer readable medium, such as a magnetic disk within a disk drive unit. Alternatively, the computer readable medium may comprise a floppy disk, removable hard disk, Flash memory 72, EEROM based memory, bubble memory storage, ROM storage 70, distribution media, intermediate storage media, execution memory of a computer, and any other medium or device capable of storing for later reading by a computer a computer program implementing the system and methods of this invention. The software adapted to implement the auto calibration mechanism of the present invention may also reside, in whole or in part, in the static or dynamic main memories 68 or in firmware within the processor of the computer system (i.e. within microcontroller, microprocessor or microcomputer internal memory).

Note that in the example embodiment presented herein, the cable modem and DOCSIS enabled processor are adapted to implement the DOCSIS 3.0 standard which provides for multiple channel video reception. It is appreciated, however, that the invention is not limited to use in a DOCSIS compatible cable modem but is applicable to numerous other differential amplifier circuit applications as well.

The network connectivity functions may also include a router or Ethernet switch core. Note that the DOCSIS MAC and PHY may be integrated into the cable modem processor or may be implemented separately.

The Texas Instruments Incorporated (Dallas, Tex.) TNETC550W and TNETC550LC platforms are designed to support the major Puma-5 use cases with the main goal being to enable customers to design and submit their own platform to the first DOCSIS 3.0 certification cycle. TNETC550W and TNETC550LC platforms are used as examples only of preferred embodiments.

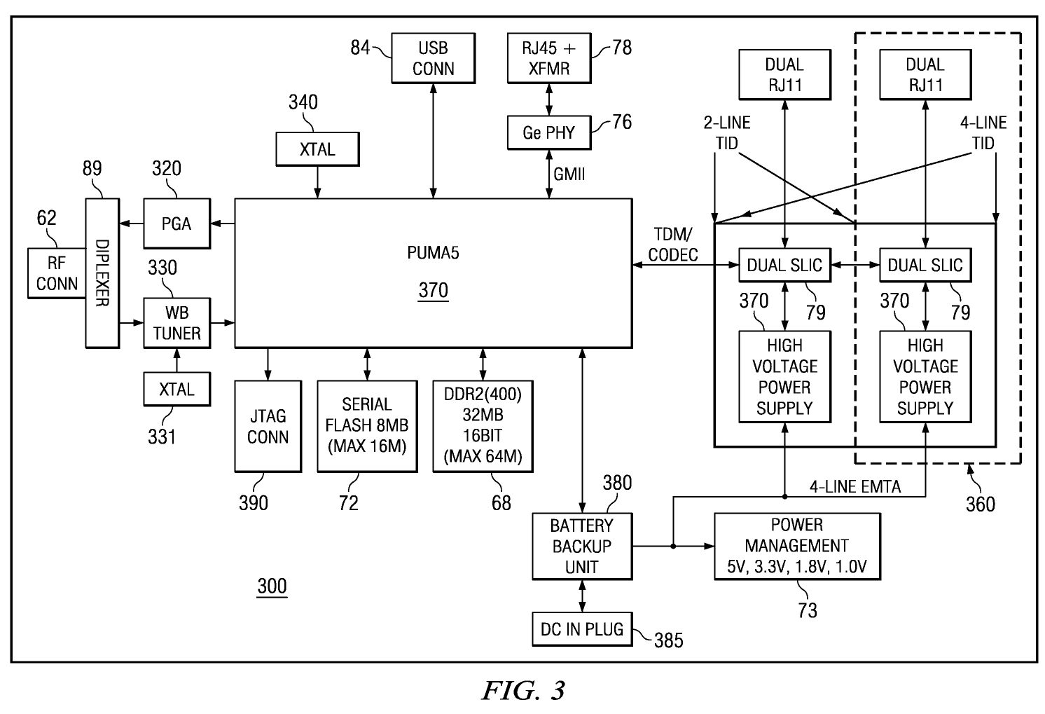

FIG. 3 is a block diagram of the Illustrative of TNETC550W and TNETC550LC platforms in accordance with the preferred embodiments. System 300 comprises RF COMM. 62, diplexer 89, programmable gain amplifier PGA 320, System 300 further comprises wideband tuner 330 and crystal for wideband tuner 331, digital front end 370 and crystal for digital front end 340 Illustrative of a digital front end 370, as an examplar only, is the PUMA5 available from Texas Instruments Incorporated (Dallas, Tex.).

Various common input ports are provided as examples only, embodiments are not limited by the type of communication ports. Communication ports comprise Ethernet connection 78 with Gigabit Ethernet PHY (GE PHY) 76, dual RJ11 360 coupled to dual SLIC 79 which are coupled to high voltage power supply 370. A battery back up 380 with DC input plug 385 are also provided. Power management 73 is also provided. Voltages available in this preferred embodiment include 5V, 3.3V, 18V and 1V. Flash memory and RAM memory are also provided. ROM may also be included but is not shown. The memory may be embedded or external to the platform.

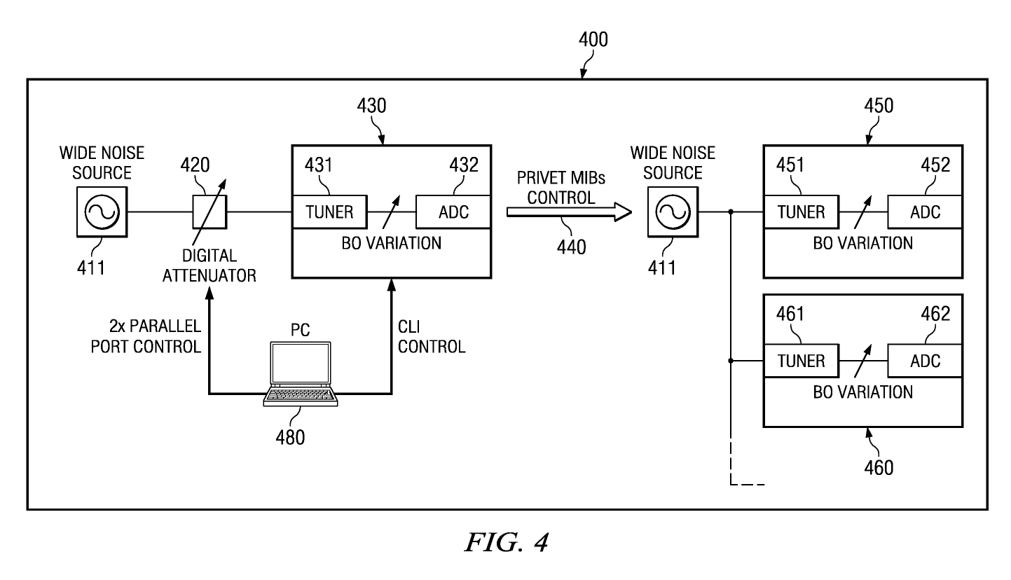

FIG. 4 is a block diagram illustrative of the automatic calibration phase improvement in accordance with an embodiment of the invention. FIG. 4 shows the two ways of calibration comparing the prior art calibration to calibration in accordance with embodiments of the invention. System 401 comprises wide noise source 411 input into digital attenuator 420 then into tuner 431 and then ADC 432 in analog front in 430. This arrangement is under PC control 480.

System 401 is in accordance with embodiments of the invention. Wide noise source 411 may split into two with one path to tuner 451 and ADC 452 in analog front in 450 and other path to tuner 461 and ADC 462 in analog front in 460. The novel calibration uses privet MIBs 440 to start the calibration and no local PC 480 is required. In addition, no computer is required to control the external noise source power since the novel calibration is done in a constant power. Additionally, it is shown that the multiple modems may be calibrated in parallel by using the novel calibration since it is automatic for each one of the modems. Only two ADCs 450 and 460 are shown but the embodiments may be extended to more ADC for calibration of multiple modems or tuners.

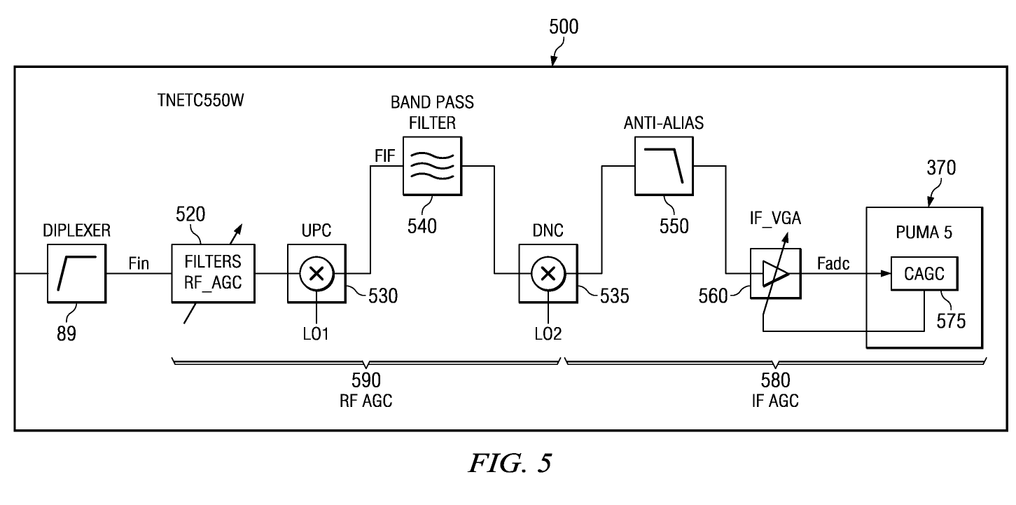

FIG. 5 is a block diagram illustrative of the architecture for analog/RF downstream path. The Downstream path 500 in accordance with an embodiment of the invention comprises a DOCSIS 3.0 diplexer 89, a wide band tuner, a radio frequency automatic gain control RF AGC 590 loop and an intermediate frequency automatic gain control IF AGC 580 loop. RF AGC 520 loop comprises filters 520, an up converter UPC 530, band pass filter 540, and down converter DNC 535. The IF AGC 580 loop comprises an anti-alias filter 550, an intermediate frequency variable gain amplifier IF VGA 560 and the digital front end 370. The radio frequency automatic gain control RF AGC 580 has an internal loop control in its close loop (automatic) state. In its open loop (manual) state, the gain may be modified by writing to the relevant register. A DOCSIS 3.0 diplexer is used in the preferred embodiment.

The IF AGC loop may be closed by the digital front-end 370. The IF AGC may also be turned to manual (open loop) and its gain can be set by writing to the relevant register.

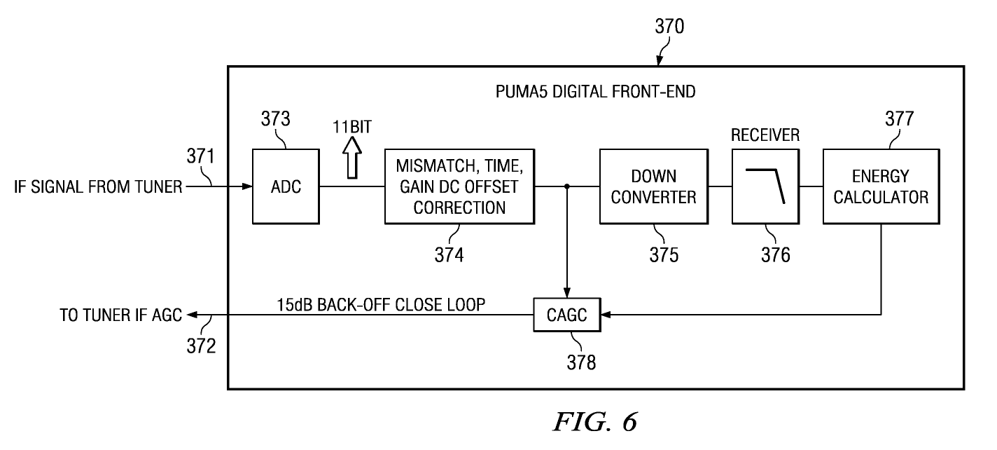

FIG. 6 is a block diagram illustrative of the digital front end 370 of FIG. 3 or 5 in accordance with an embodiment of the invention. Illustrated, as an examplar only, is the PUMA5 available from Texas Instruments Incorporated (Dallas, Tex.). Digital front end 370 comprises, analog digital converter ADC 373, down converter 375, filter 376, energy calculator 377, calibrated agc 378. Mismatch, time, gain DC offset correction is performed in 374. IF signal from tuner 371 IF agc to turner 372.

The digital front end has the ability to change ADC input power by using back-off variation. This novel attribute provides for automatic calibration in accordance with embodiments of the invention. Moreover, the digital front-end is operable to measure channel power by using digital energy calculator in the receiver. The energy calculator value is the power difference of the measured signal from the maximum input power on the ADC's input.

Calibration process defines the DS system gain to total input power and main issue defining the gain of IF AGC. The Table 1 below describes reported power equation parameters that may be discovered over calibration process. This Table is example only from a preferred embodiment.

TABLE 1

| Reported Power Equation | |
|---|---|
| Parameters | Description |
| +Pin_ref | Initial power measured at the reference |
| | state |
| +G(Diplexer + BPF + | Function of input frequency and input filter |
| NoiseSourse) | |
| +G(RF_agc) | Function of input frequency and RF_agc |
| | code |
| +G(FIFF) | Function of 1st IF frequency |
| +G(Vifagc) | Function of IF AGC voltage |
| +G(anti-aliasing filter) | Function of tuner output frequency |
| +deltaDET | Difference between the actual energy |
| | calculator value and the reference case |
| | one. |
| +QAM_correction | Additional power correction related to the |
| | QAM use case. For NA only |
| +EURO_correction | Additional power related to the BW |
| | difference in NA and EURO DS signal. |
| −11 | BW correction number. |

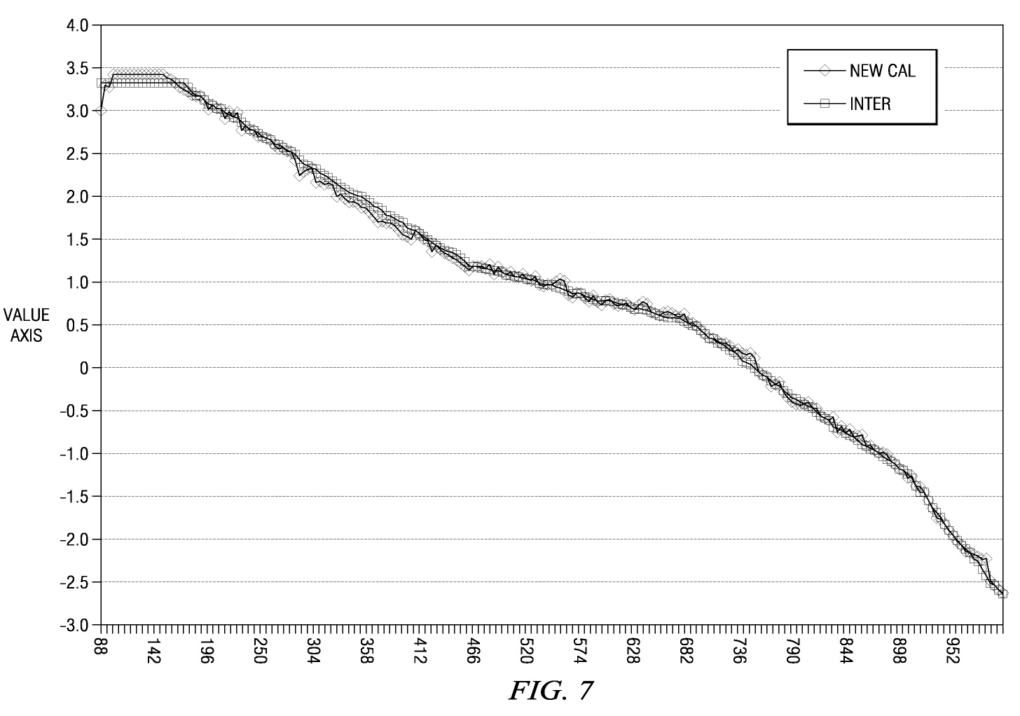

Before starting the downstream calibration process, the noise source vector may be inserted into a calibration table for frequencies from 48 MHz to 1002 MHz in one Pin_ref power. FIG. 7 shows the noise source used to calibrate the device. The “New Cal” is the real noise frequency response and the “inter” is for the approximated noise behavior to be inserted to the CM for the calibration.

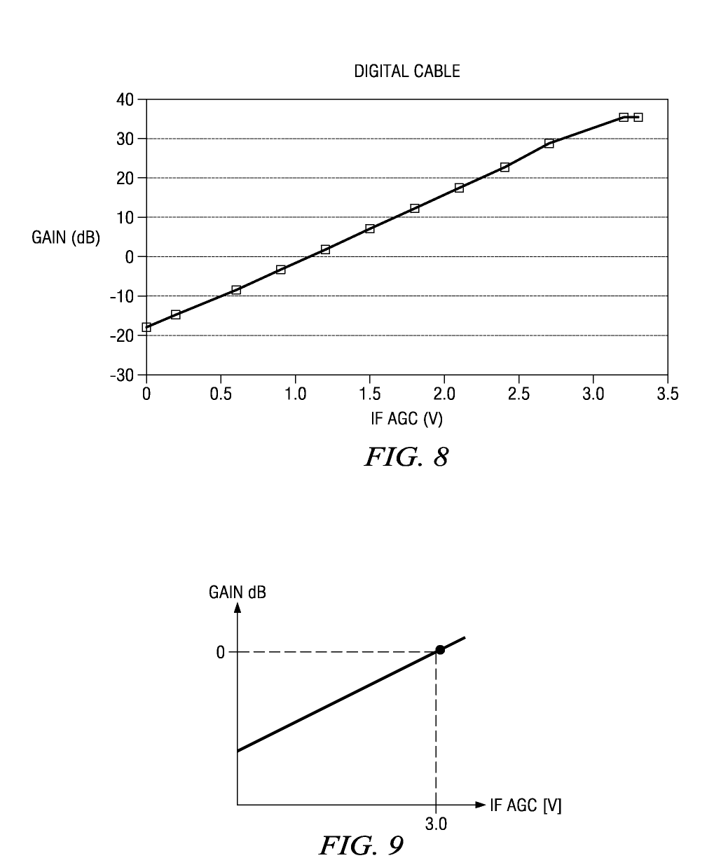

FIG. 8 shows the IF-AGC gain to voltage relation. This graph/relation is used by the calibration algorithm to learn the different chain components response.

This chart and figure are example only from a preferred embodiment.

TABLE 2
Noise correction vector

| Fr In [MHz] | Power | Delta Power |
|---|---|---|
| 88 | 3.343 | 2.343 |
| 166 | 3.343 | 2.343 |
| 466 | 1.193 | 0.193 |
| 540 | 1 | 0 |
| 682 | 0.523 | −0.477 |
| 910 | −1.287 | −2.287 |
| 1000 | −2.627 | −3.627 |

The calibration process is based on the power reference value as shown in FIG. 9. FIG. 9 shows that there is a relative gain used for the calibration. The first calibrated point, the reference channel, is selected as the 0 gain. All the other results are related to this point.

Reference point describes the relation of the input power (Pin) to the IF VGA register for the first point as shown below:

TABLE 3
Ref. Channel Calibration

| Pin [dBmv] | Fr In [MHz] | RF_AGC [code] | Fr SAW [MHz] | Fr ADC [MHz] | Back-Off [dB] | IF VGA [dB] | IF Register | DET Power [dB] |
|---|---|---|---|---|---|---|---|---|
| 1.05 | 539.959 | 0 | 1247 | 74 | 16 | 0 | 143 | 33.58 |

Referring again to FIGS. 5 and 6, for intermediate frequency AGC calibration, there is insignificant or no change in the IF VGA's 560 frequency response with respect to IF AGC voltage. Freeze RF AGC 590 and adjust ADC's 520 back off. The IF AGC loop 580 will close by PHY CAGC 680.

See table below

TABLE 4

| | | Pin | IF VGA | IF |
|---|---|---|---|---|
| Back-Off [db] | Back-off [Hex} | [dbmV] | [db] | Reg. |
| 16 | 337 | 1 | 0 | 400 |
| 18 | 207 | | 2 | 350 |
| 20 | 147 | | 4 | 300 |
| 22 | CE | | 6 | 250 |
| 24 | 82 | | 8 | 200 |
| 26 | 52 | | 10 | 150 |
| 28 | 33 | | 12 | 100 |
| 30 | 20 | | 14 | 50 |
| 32 | 14 | | 16 | 0 |
| 34 | D | | 18 | −50 |
| 36 | 8 | | 20 | −100 |
| 38 | 5 | | 22 | −150 |
| 39 | 4 | | 23 | −200 |

Table 5 shows radio frequency calibration. There is no frequency dependence. Input power is fixed, change RF automatic gain control code and read intermediate frequency automatic gain control register in order to calculate RF automatic gain control attenuation relative to the reference point.

TABLE 5
RF agc Calibration

| RF_agc [code] | RF_agc [dB] | IF Register |
|---|---|---|
| 0 | 0 | 400 |
| 24 | −1.23 | 350 |
| 66 | −2.98 | 300 |
| 84 | −4.12 | 250 |
| 105 | −5.12 | 200 |
| 127 | −6.12 | 150 |

Table 6 shows AAF+ADC response calibration. Power input fixed close loop. Freeze RF and IF automatic gain control. Scan IF frequencies. Read energy register for each point

TABLE 6
AAF

| # | FrADC | AAF_dB | Det |
|---|---|---|---|
| 1 | 30 | 0.17 | 37.17 |
| 2 | 36 | 0.09 | 37.09 |
| 3 | 42 | −0.01 | 36.99 |
| 4 | 48 | −0.06 | 36.94 |
| 5 | 54 | −0.07 | 36.93 |
| 6 | 60 | 0 | 37 |
| 7 | 66 | 0.01 | 37.01 |
| 8 | 72 | 0 | 37 |
| 9 | 78 | −0.04 | 36.96 |
| 10 | 84 | −0.11 | 36.89 |
| 11 | 90 | −0.15 | 36.85 |
| 12 | 96 | −0.2 | 36.8 |
| 13 | 102 | −0.19 | 36.81 |
| 14 | 108 | 0 | 37 |
| 15 | 114 | 0.37 | 37.37 |
| 16 | 120 | 1.02 | 38.02 |
| 17 | 126 | 2.2 | 39.2 |

For BPF filter and diplexer calibration, fixed power input on close loop. RF_LO scan input frequency. Freeze RF automatic gain control and intermediate frequency automatic gain control. Freeze tuner setting. Read energy register in order to calculate BPF attenuation. A 2^{nd} order or linear interpolation method is used depending on location inside filter.

Surface Acoustical Wave SAW filter calibration process begins with power input fixed on close loop. Freeze RF AGC and IF AGC. Read energy detector register. The first point is the reference.

TABLE 7
SAW

| # | FrSAW | SAW_dB | Det |
|---|---|---|---|
| 1 | 1193 | 0.38 | 37.38 |
| 2 | 1199 | −0.52 | 36.48 |
| 3 | 1205 | −0.1 | 36.9 |
| 4 | 1211 | 0.03 | 37.03 |
| 5 | 1217 | 0.08 | 37.08 |
| 6 | 1223 | −0.4 | 36.6 |
| 7 | 1229 | −0.21 | 36.79 |
| 8 | 1235 | −0.5 | 36.5 |
| 9 | 1241 | −0.42 | 36.58 |
| 10 | 1247 | 0 | 37 |
| 11 | 1253 | 0.18 | 37.18 |
| 12 | 1259 | −0.03 | 36.97 |
| 13 | 1265 | −0.08 | 36.92 |
| 14 | 1271 | 0.08 | 37.08 |
| 15 | 1277 | 0.68 | 37.68 |
| 16 | 1283 | 0.66 | 37.66 |
| 17 | 1289 | 0.28 | 37.28 |
| 18 | 1295 | 0.52 | 37.52 |
| 19 | 1301 | 1.88 | 38.88 |
| 20 | 1307 | 3.6 | 40.6 |

The number is all the tables are for an example only. Different values will be received for each modem and each time the calibration is done.

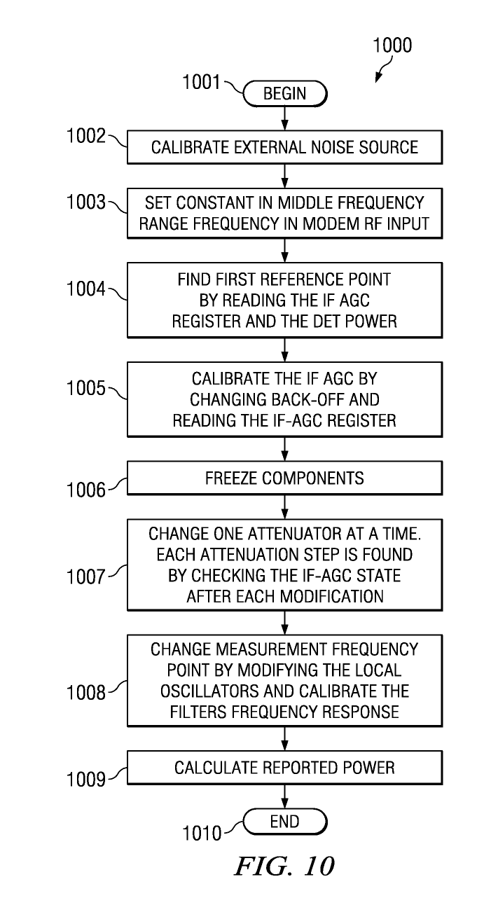

FIG. 10 is a flowchart illustrative of a method in accordance with an embodiment of the invention. Method 1000, begans 1001 by external noise source calibration 1002. At step 1003, set constant 1 dBmv @BW=100 MHZ in the middle frequency range frequency (about 540 MHz) in the modem RF input. The first reference point is found by reading the IF AGC register and the DET power when the entire chain is configured as “reference channel.” This is step 1004. At 1005, calibrate the IF AGC by changing the back-off and reading the IF-AGC register. At 1006 and 1007, calibrate the attenuators by freezing all the components and changing only one attenuator at the time. Each attenuation step is found by checking the IF-AGC state after each modification. By using the Puma5 detector, change the measurement frequency point by modifying the local oscillators and calibrate the filters frequency response at step 1008. The reported power will be calculated by using the equation described in the document—1009. Ending 1010.

Use of ADC's back-off variation for IF_agc calibration means that instead of changing input power thought external digital attenuator in order to characterize cable modem's downstream path gain, the input power may stay stable and use ADC back-off variation for downstream gain control.

Embodiments of the invention provide reduced downstream calibration time on production. The prior art calibration implementation is capability limited. Each calibration station was only able to calibrate one cable modem simultaneous. Embodiments of the invention facilitate a calibration process wherein each station can serve a lot of cable modems simultaneous. Thus, reducing the time of production significantly.

Embodiments of the invention eliminate the need for external PC control. The prior art calibration application ran on external PC because it was require external digital attenuator control. Embodiments of the invention run on cable modem image without needs of external component control. Thus, run calibration cycle by single command.

Embodiments of the invention use stable power of wideband noise for wide frequency calibration. All the calibration process is performed using a wide band noise source. There is no need to control the wideband noise input power. While connecting a wide noise, the cable modem is capable to calibrate itself over wide frequencies by using single command.

Embodiments of the invention perform IF_agc calibration through Back-off variation. The back-off value determines different downstream gain, means different IF_agcs gain in order to characterize it.

Embodiments of the invention use IF_agc known calibration for RF agcs Attenuator calibration. A purpose of the IF calibration is to find the relation of the IF VGA gain to the IF VGA gain register by changing the ADC's BO for the entire DOCSIS3.0 range. The RF calibration process uses the IF VGA register behavior and the internal Energy calculator is used to find the gain/attenuation vs. code and the frequency response for each one of the RF components.

Embodiments of the invention use Receiver energy detector for filters response calibration. By freezing downstream path state (gain) and by tuner local oscillator's adjustment, energy detector calculator may be used for filter response calibration.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method for calibration comprising:
connecting to a fixed and stable power wide band noise source; and
the cable modem calibrating itself over wide frequencies while connecting said wide noise source.

2. The method of claim 1, wherein the calibrating is an intermediate frequency IF calibration process and said IF calibration process is accomplished through back-off variation and the back-off value determines a downstream gain.

3. The method of claim 1, wherein the calibrating is a radio frequency calibrating process and uses an intermediate frequency variable gain amplifier IF VGA register behavior and a digital front end internal energy calculator to find a gain/attenuation vs. code parameter and a frequency response for each one of a plurality of RF components.

4. The method of claim 1, further comprising:
freezing a downstream path state;
adjusting a tuner's local oscillator; and
using said digital front end internal energy calculator for filter response calibration.

5. The method of claim 1, wherein each of a calibration station of a plurality of calibration stations may serve two or more cable modems simultaneous.

6. The method of claim 5, wherein said calibrating cycle is ran by a single command.

7. A method for calibration comprising:
calibrating an external noise source;
setting a constant in a middle frequency range frequency in the modem radio frequency RF input;
finding a first reference point by reading the intermediate frequency automatic gain control IF AGC register and the DET power when the entire chain is configured as reference channel;
calibrating the IF AGC by changing a back-off and reading the IF-AGC register;
calibrating a plurality of attenuators comprising:
freezing at least one component of a plurality of components; and
changing only one attenuator at a time, wherein each attenuation step is found by checking the IF-AGC state after each modification;
changing a measurement frequency point by modifying a plurality of local oscillators and calibrate at least one filter frequency response.

8. The method of claim 7, wherein the constant is 1 dBmv @BW=100 MHz and the middle frequency range frequency is approximately 540 MHz

9. The method of claim 7, wherein the reported power (P_reported) is be calculated by using:
P_reported=noise correction+Pin_ref+GDiplexer+BPF+NoiseSourse)+G(RF_agc)+G(FIFF)+G(Vifagc)+G(anti-aliasing filter)+deltaDET—QAM_correction+EURO_correction−11.
